(19) United States
(12) Patent Application Publication
(10) Pub. No.: US 2007/0074878 A1
(43) Pub. Date: Apr. 5, 2007

(54) Lift wheel for farm implement

(76) Inventor: John Franklin, Tifton, GA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/240,661

(22) Filed: Sep. 30, 2005

(51) Int. Cl. A01B 63/00

(52) U.S. Cl. 172/452

(57) ABSTRACT

A lift wheel assembly for attachment to a farm implement to selectively position the implement between a working condition in which the tools of the implement engage with and work soil in a field, and a transport condition in which the tools are elevated above the soil surface permitting the farm implement to be repositioned. The lift wheel assembly is attachable to a toolbar of the implement by a bracket. It includes a lift beam that has a ground wheel at one end and is pivotally attached to the bracket by a pivot arm at a second end. An actuator operates to pivotally displace the lift beam and ground wheel to selectably position the ground wheel aft of the implement's center in a transport state and forward of the center of gravity in a working state.

### FIELD OF THE INVENTION

The present invention relates generally to farm implements and more particularly to trailer mounted farm implements. With even greater particularity the invention relates to a system for providing a farm implement with a lift wheel assembly, movable from an extended transport position to a retracted working position. The lift wheel system of present invention further permits employment as a modification or conversion to an existing farm implement.

### BACKGROUND OF THE INVENTION

A traditional problem faced by many farmers is the difficulty of transporting a farm implement between a storage or maintenance area and the fields where the implement is needed to work the soil, treat a growing crop, harvest a crop, or otherwise tend to the business of farming. Because a given implement is primarily designed to accomplish a particular working task, issues regarding the transport of the implement to the field, or between dispersed fields are addressed only as a secondary consideration, if at all. The transport problem becomes particularly acute where the power of modem tractors permits the employment of working implements having substantial size.

One such solution to the transport problem is the integrally mounted farm implement. Integrally mounted implements are generally mounted to a host tractor via multiple attachment points extending from a frame that can be hydraulically activated from the cab of the host tractor. Attachment of the implement to the movable frame permit the implement and host tractor function as a single integrated unit. Activation of the hydraulics permits the implement to be raised and lowered between a working position, wherein implement tools are positioned for engagement and working of the soil in a field, and a transport position, wherein the implement and tools are elevated with respect to the soil permitting the implement to be transported between fields.

While a properly configured integrally mounted implement can be quite effective in working a field, the complexity of attaching the implement to the tractor and the many adjustments required to properly configure the integrally mounted implement to effectively work the soil can be a time consuming operation. As such it unduly restricts the ability of using the tractor for the myriad of tasks required in the typical farming operation apart from its use with the particular implement.

To address the limitations of integrally mounted implements, towed implements have found a degree of acceptance. Towed implements are those that are attached to a host tractor at a single point, normally a draw bar, extending from the aft end of the tractor, permitting ready attachment to the host vehicle. While some implements are initially designed as a towed implement, the substantial cost of modem farm implements precludes abandonment of an integrally mounted implement in favor of a towed implement. Accordingly, various conversion kits have been developed to convert an integrally mounted implements to a towed implement, generally by adaptation of a tongue assembly to the former integral mount attachment points. With these adaptations, the requirement for a suitable transport platform for the towed implement becomes a necessity for effective utilization of the implement.

While various attempts have been made in the art to address the aforementioned transport considerations by the incorporation of lift wheels into a towed implement, these attempts do not adequately address the various design considerations necessary to safely and effectively transport the implement. Similarly, where transport considerations are addressed, they often sacrifice efficiencies in the utilization of the implement for its working task, are overly complex or are otherwise not cost effective.

One method of addressing the transport requirement for a farm implement is the utilization a set of transport wheels or “dollies” that are adapted to transport a wide variety implements. By their nature they require adaptation to a particular implement, or a particular implement configured for a specific task. While dolly sets offer the advantage of being adaptable to a wide variety of implements and implement configurations, the implement itself remains without a self contained transport mechanism, thereby requiring that the dolly set be brought to one or more implements or locations. In addition it merely substitutes the time consuming task of attaching and adjusting the integrally mounted implement with the time consuming task of attaching the dolly set to the implement for transport.

The limitations of dolly sets have been addressed in the art with the adaptation of various lift wheel configurations to farm implements. In general, lift wheel adaptations fit a pair of movable transport wheels to the implement. The transport wheels are extended for transport and then retracted when the implement is utilized for working a field. These adaptations generally fit the lift wheels to the tool bar or implement frame

One such adaptation utilizes a pair of transport wheels that are positioned forwardly of the tool bar when extended to the transport position and swing further forwardly to place the implement in its working position. This particular configuration presents a significant shortcoming because the positioning of the transport wheels forwardly of the tool bar introduces negative loading at the tongue and drawbar interface between the implement and the tractor. The negative loading at the tongue contributes to substantial instability of the implement as it is transported as well as other undesirable loading characteristics as discussed in U.S. Pat. No. 6,758,254 to Myers.

As disclosed in Myers, it is desirable to position the wheels reawardly in relation to the tool bar such that the wheels are supportive in a position aft of the implement's center of gravity when extended in the transport position. This positioning aft of the center of gravity is a primary consideration for safely and effectively transporting the implement. However, a significant shortcoming of the configuration disclosed in Myer is that it relies on hydraulic pressure to maintain the lift wheels, and thereby the implement, in an elevated transport position. Failure of the hydraulics during transport can produce catastrophic effects. Similarly, as pointed out in Myers, the hydraulic pressure must also be controlled so as to maintain the wheels in phase, thus adding to the complexity of the implement.

While Myers' placement of the transport wheels aft of the center of gravity addresses the negative tongue loading flaws presented by forward mounted configurations, the transport wheels disclosed in Meyers extend further rearwardly of the tool bar to lower the implement to its working position.

As is well known in the art, it is desirable to control the vertical position of the implement's tools with respect to their engagement with the soil. Conventionally, this task is referred to as gauging and is normally accomplished by a set of gauging wheels operatively attached to the implement and extending forwardly of the tool bar. In the system disclosed by Myers, a separate set of gauge wheels, mounted in tandem with the transport wheels, are utilized in combination with the rearwardly extending transport wheels, thus adding needless weight and complexity to the entire implement.

Accordingly, there is a need in the art for providing a towed implement with a safe and effective transport mechanism having reduced complexity in operation and application. There also remains a need for safely and effectively adapt an integrally mounted implement to a towed implement having the same favorable characteristics.

### BRIEF SUMMARY OF THE INVENTION

The present invention provides a unique solution to the aforementioned shortcomings in the prior art. The lift wheel assembly contemplated by the present invention provides the ability to readily reconfigure a farm implement between a transport state, wherein a support structure and ground wheels of the lift wheel assembly are positioned aft of the implement's center of gravity to alleviate undesirable loading characteristics, and a working condition, wherein the support structure is rotated forwardly to position the ground wheels forwardly of the implement's center of gravity such that the ground wheels support the implement tools at a desired gauging depth to work the soil in a field.

The lift wheel assembly comprises a main lift beam having a pivot arm extending from a first end of the lift beam and a ground wheel disposed at a second end of the lift beam for rotation about an axle mounted transversely within a fork assembly. The lift wheel assembly is readily attached to an implement the tool bar via a bracket that permits forward and aft pivotal rotation of the lift beam and the ground wheel. Its size permits attachment to the toolbar between the soil working tools extending from the toolbar.

Because the lift wheel assembly utilizes the same ground wheel for both transport and gauging the implement tools in the working state, the contemplated design provides substantial cost savings in terms of materials as well as reducing the complexity of the overall structure.

The lift wheel assembly contemplated by the invention is also readily adaptable to an existing farm implement. With the addition of a tongue assembly, the lift wheel assembly of the present invention can fully convert an existing integrally mounted implement to a towed implement while providing all the advantages described herein, obviating the need for substantial capital outlays required to procure a new implement having the same advantages.

### BRIEF DESCRIPTION OF THE SEVERAL VIEWS OF THE DRAWINGS

FIG. 1 depicts a side view of a lift wheel assembly in a transport position;

FIG. 2 depicts a side view of a lift wheel assembly in a working position;

FIG. 3 depicts a front perspective view of a lift wheel assembly in a transport position;

FIG. 4 depicts a front perspective view of a lift wheel assembly in a working position;

FIG. 5 depicts a front perspective view of a farm implement with a lift wheel assembly in a transport position;

FIG. 6 depicts a partial frontal view of a farm implement with a lift wheel assembly in a working position;

FIG. 7 depicts rear end view of a farm implement and tractor with a lift wheel in a transport position;

FIG. 8 depicts a tongue and drawbar attachment of an implement to a tractor.

### DETAILED DESCRIPTION OF THE INVENTION

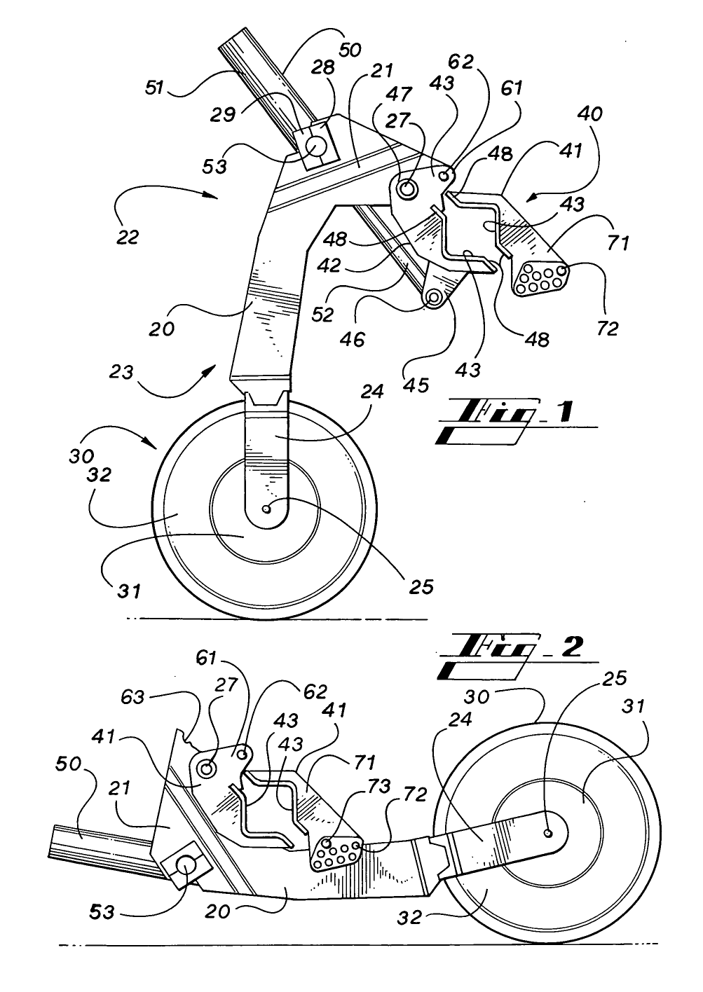

The many objects of the invention are accomplished by the lift wheel assembly of the present invention, which may be seen in reference to the several drawings and described in the following detailed description of the invention. In reference to FIGS. 1-4, the lift wheel assembly 10 comprises a main or lift beam 20, having a pivot arm 21 extending from a first end 22 of the lift beam 20. A ground wheel 30, comprising a wheel assembly 31 and tire 32, extends from a second end 23 of the main beam 20. The ground wheel 30 is disposed for rotation about an axle 25 mounted transversely within a fork assembly 24.

As shown, the pivot arm 21 extends generally forwardly of the main beam 20 when the main beam is oriented vertically and is comprised of a pair of substantially parallel forwardly extending plates joined by a cross piece. Main pivot apertures 26 are located at a forward end of the pivot arms 21 to receive a pivot pin 27 for attachment of the lift beam 20 to a bracket assembly 40 through a corresponding pivot aperture 47 defined in the bracket assembly 40.

Bracket assembly 40 is adapted to attach the lift wheel assembly 10 to a tool bar 11 of a farm implement 12. Preferably, the bracket assembly 40 is of a two piece construction having a forward bracket element 41 and an aft bracket element 42 which have inner tool bar engagement portions 43 shaped to engage the toolbar 11 and removably attach the bracket 40 to the tool bar 11. Bracket elements 41 & 42 have a width to provide lateral stability to the lift wheel assembly 10. Bracket engagement flanges 48 extend from each side of the tool bar engagement portions 43 of bracket elements 41 & 42 and are joined by bolts. In the particular embodiment shown, the tool bar 11 has generally a square shape, accordingly, the tool bar engagement portions 43 are shaped such that they mate to the toolbar 11 for added strength to support the torsional loading on the bracket 40 and tool bar 11.

Bracket assembly 40 further comprises a first arm 44, or bracket pivot arm 44, that extends generally rearwardly relative the toolbar engagement portions 43. Bracket pivot arm 44 has a bracket pivot aperture 47 defined therein for receiving pivot pin 27. Pivot pin 27, main pivot aperture 27, and bracket pivot aperture 47 are suitably supported by bushings, bearings and the like to support the loads and pivotal displacement of the main beam 20 about the pivot pin 27.

A second arm 45, or actuator arm 45, extends generally downwardly relative the toolbar engagement portions 43. An actuator attachment aperture 46 is located at an end of the actuator arm 45 distal to the toolbar engagement portion 43 and provides a fixed point relative the implement 12 for operative engagement of an actuator 50 with the lift beam 20. For added strength a pair of actuator arms 45 may be utilized for attachment of the actuator 50 to the bracket 40.

Actuator 50 generally comprises an actuator body 51 and an extensible and retractable actuator rod 52 and is operatively attached to the lift wheel assembly 10 between the actuator arm 45 and pivot arm 21. Preferably a trunion 53 extends from the walls of actuator body 51 and pivotally attaches actuator 50 to the main beam 20. Pivot arm 21 includes a trunion mount 28 positioned near a rearward end of the pivot arm 21. A trunion retainer cap 29 attaches to trunion mount 28 via bolts to retain trunion 53 and actuator 50 in position relative pivot arm 21. Trunion 53, trunion retainer block 28 and trunion retainer cap 29 should be suitably supported by a bushing or bearing to support the loading on trunion 53 and permit pivotal displacement of actuator 50. In the preferred embodiment actuator 50 is a hydraulic cylinder connected by hydraulic lines or hoses 55 & 56 to a pressurized source of hydraulic fluid 54, which is normally present on a tractor used to pull the implement.

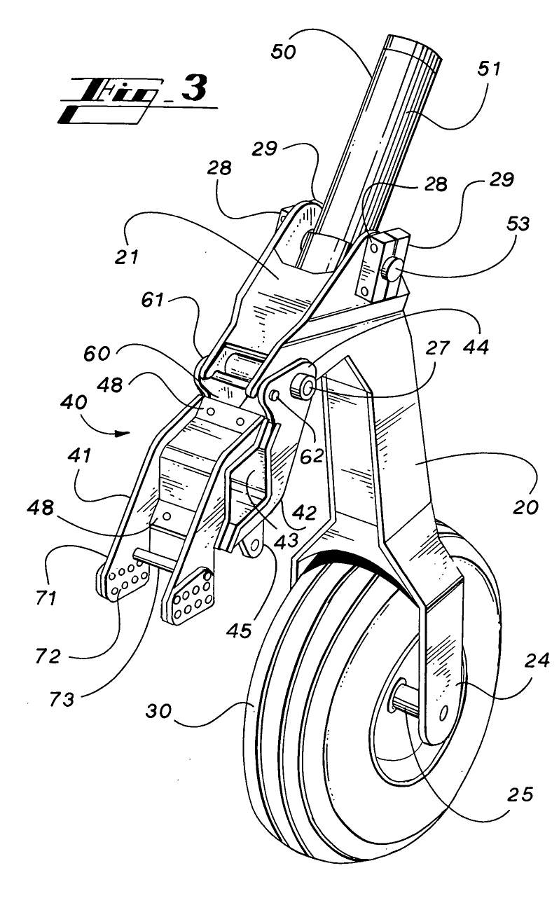

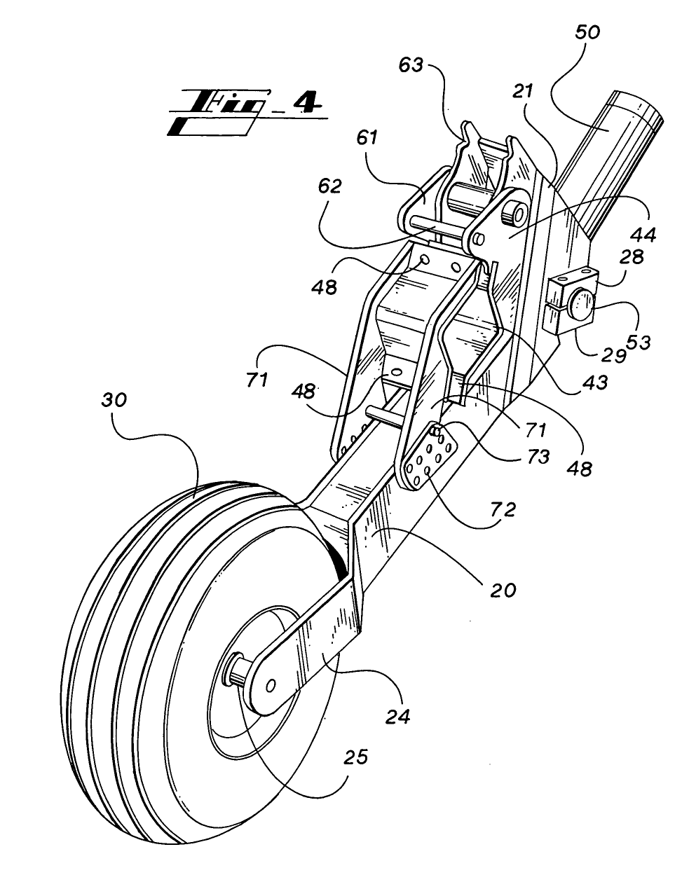

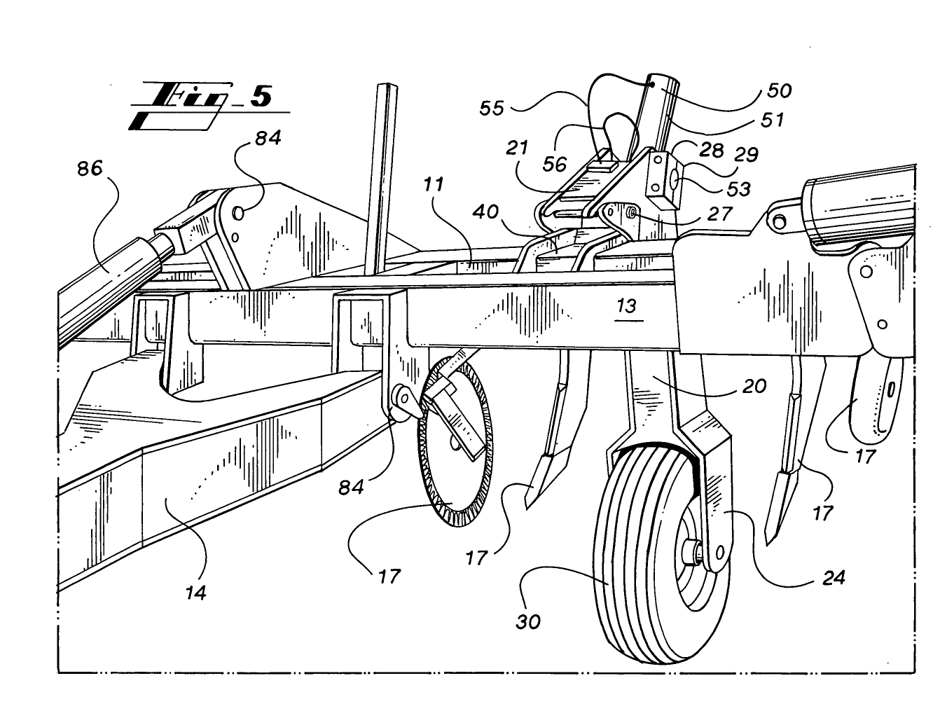

The basic operation of the lift wheel assembly 10 may be seen by reference to and comparison of FIGS. 1 and 3 with FIGS. 2 and 4 wherein the tool bar and farm implement are omitted for clarity. As may be seen in FIGS. 1 and 3, actuator 50 is extended such that lift beam 20 and ground wheel 30 are positioned aft of bracket assembly 40. It should be further noticed that in this position the bracket assembly 40 is substantially elevated with respect to the ground. Preferably, extension of actuator 50, and thereby rearward displacement of main beam 20 is limited by an aft mechanical stop 60, which engages with a forward end of pivot arm 21. In the embodiment shown mechanical stop 60 comprises a forward extension 61 of bracket pivot arms 44 with a stop pin 62 transversely disposed between extensions 61. Pivot arms 21 may be adapted with arcuate indentations 63 to conform to the surface of stop pin 62. The depth of indentations 63 or the diameter of stop pin 62 may be varied to modify the limit of displacement for main beam 20. By way of comparison, FIGS. 2 and 4 depict actuator 50 in a retracted state such that lift beam 20 is rotated forwardly relative bracket assembly 40 and ground wheel 30 is positioned forward of bracket assembly 40. As may be readily seen, the bracket assembly 40 is substantially lowered from the extended state so that it is positioned in closer proximity to the ground, in a gauging state. Preferably retraction of actuator 50 is limited by a forward mechanical stop 70 to set a desired elevation of the bracket assembly 40 relative to the ground. More preferably a forward mechanical stop 70 includes plurality of selectable positions to adjust the desired gauging depth.

In this case, bracket element 41 further comprises a pair of substantially parallel forwardly extending arms 71 having a plurality of gauging apertures 72 defined therein. Gauging apertures 72 receive a gauge setting pin 73 such that on forward displacement of lift beam 20, gauge setting pin 73 contacts a forward surface of lift beam 20 at the desired gauge depth setting, thereby limiting further displacement of the lift beam 20.

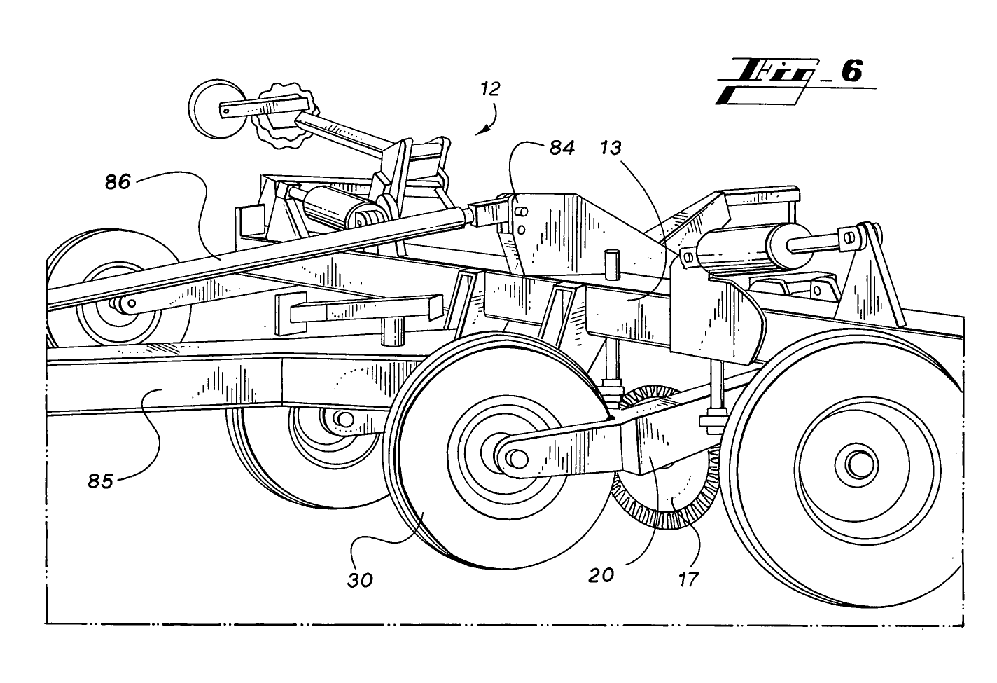

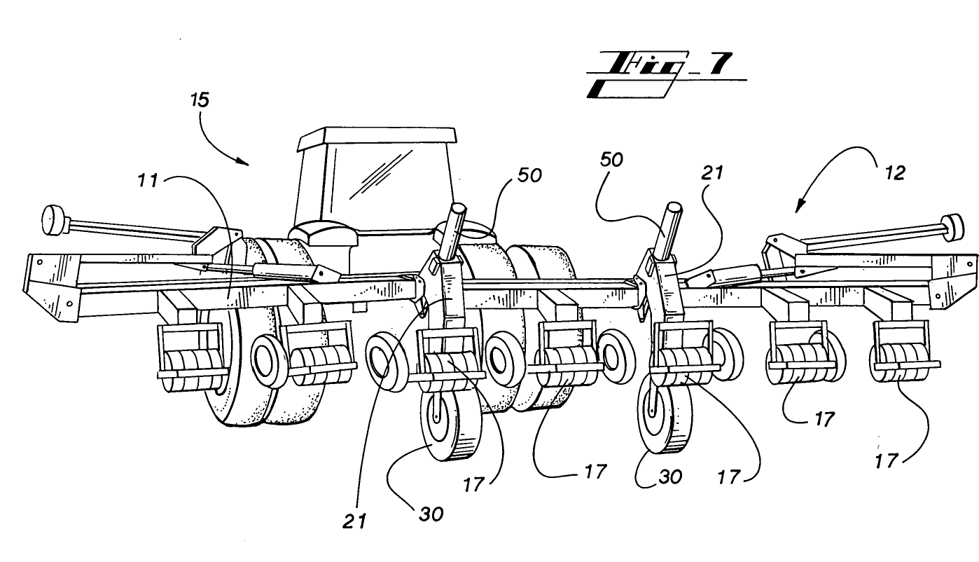

Having thus described the lift wheel assembly 10, the following will describe the application of the lift wheel assembly 10 to a farm implement 12. As may be seen in reference to FIGS. 5-8 a farm implement 12 generally comprises a support frame 13 having a longitudinally extending implement tool bar 11 to which a plurality of tools 17, such as a disk, ripper, and the like are mounted via brackets 18. The tools 17 are mounted to tool bar 11 in spaced relation so as to work the soil in a field, preferably in equally spaced rows. A tongue assembly 14 operatively connects the implement 12 to a draw bar 16 of a tractor 15. In operation the tractor 15 draws the implement 12 across the ground such that tools 17 engage with and work the soil.

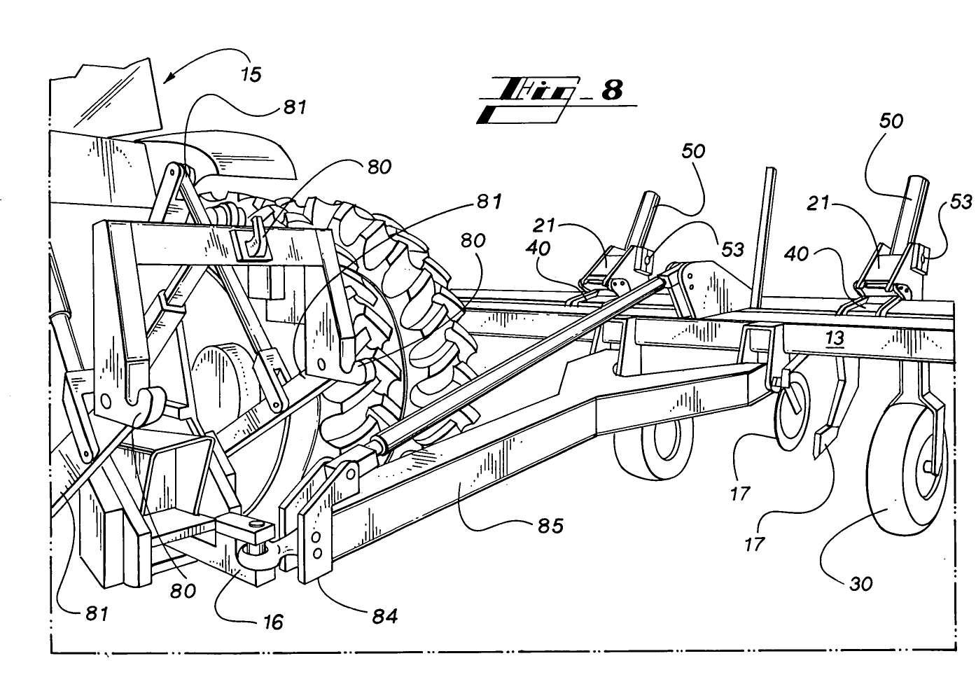

As just discussed the tools 17 are mounted to the tool bar 11 in spaced relation generally defining the rows in a field. As may be seen in reference to FIG. 5, the lift assembly 10 of the present invention is operatively attached via brackets 40 to the tool bar 11 in spaces between the tools 17. As may be seen in particular reference to FIG. 7, a pair of lift wheel assemblies 10 may be seen with the actuators 50 extended to position the lift beam 20 and ground wheel 30 in the transport state. It should be particularly noted that the attachment of bracket assembly 40 to the tool bar 11 positions pivot apertures 26 & 46 and pivot pin 27 aft of the toolbar 11 and aft of the implement's center of gravity. Accordingly, it will be apparent that the weight of the implement supported by the ground wheels 30 and lift beam 20 is distributed such that it is transferred to the pivot pin 27 and aft mechanical stop 60. As such, lift beam 20 and ground wheel 30 may be maintained in the transport state solely by the weight of the implement such that even with a total failure of the actuator 50, the implement 12 will remain elevated in its transport condition. Moreover, it should be noted that because aft mechanical stops 60 limit the displacement of the respective lift beams 20 and ground wheels 30, the need to regulate the actuators 50 to maintain the lift wheel assemblies 10 in phase is eliminated.

To transition the implement from the transport state depicted in FIGS. 5 and 7 to the working state depicted in FIG. 8, work is applied to retract actuator 50 and displace lift beam 20 and ground wheel 30 forwardly with respect to toolbar 11. It should be noted that as lift beam 20 is rotated forwardly by actuator 50, lift beam 20 and ground wheel 30 will slightly elevate the implement 12 above its transport height. As the lift wheel 30 passes forwardly of the pivot pin 27, the implement 12 will begin to lower to its working state.

As may be seen in reference to FIG. 8, retraction of the actuator 50 positions lift beam 20 and ground wheels 30 in the working state with ground wheels 30 positioned forwardly of tool bar 11 and set at a desired gauging height to position tools 17 for engagement with the soil. The implement 12 is then ready be drawn forwardly across the field in the gauging or working condition to work the soil. Upon reaching the end of a row after working the soil, it is desirable to be able to temporarily disengage the tools 17 as the implement is turned about to work the soil in an opposite direction such as to define or work an adjacent row in the soil. In this instance, actuators 50 may be partially extended to temporarily disengage tools 17 from the soil without complete extension to the transport position. The implement may be turned about and aligned for a subsequent pass across the field. When the implement is aligned to begin a subsequent pass actuators 50 are again retracted to the desired gauging depth to engage tools 17 with the soil for a subsequent traversal of the field. The above described lift wheel assembly 10 may be adapted to a towed implement 12 and also be applied to an integrally mounted implement 12 to permit conversion of the integrally mounted implement to a towed implement as further described herein. In particular reference to FIG. 9 an integrally mounted implement is shown with adaptations to convert it to a towed implement. Tractor 15 comprises an integral mount frame 80 having a plurality of mount hooks 81 coupled to the mount frame 80. Mount frame 80 is pivotally attached to the tractor 15 via elevation arms 81 and operable by extension and retraction of an elevation cylinder 84. The integrally mounted implement comprises a plurality of implement attachment points 84 to which the mount hooks 81 of the tractor engage. The implement is raised or lowered by activation of elevation cylinder 83 between a working state and a transport state. Adaptation of the integrally mounted implement to a towed implement comprises attachment of a substantially Y shaped tongue assembly 14 to the implement. The tongue assembly comprising a main tongue beam 87 having a hitch assembly 85 at a forward end and a pair of tongue arms 86 extending rearwardly and outwardly from the aft end of the main tongue beam 87. The ends of tongue arms 86 are pivotally attached to the lower implement attachment points 84. An adjustable torsion rod 88 is attached between the upper implement attachment point 84 and the hitch 85. Along with the adaptation of the tongue assembly 14, a plurality of lift wheel assemblies 10 are attached to the implement as described hereinabove to complete the adaptation of the integrally mounted farm implement to the towed implement of the present invention.

Having thus described a preferred embodiment of the invention and its method of application, it will be apparent to those of skill in the art that various modifications and adaptations to the invention can be made without departing from the scope of the invention as defined in the accompanying claims.

What is claimed is:

1. A lift wheel assembly for attachment to a farm implement to selectively position the implement between a working condition, whereby a plurality of tools mounted to a transverse toolbar of said implement engage with and work soil in a field, and a transport condition, whereby the tools are elevated above the soil surface permitting the farm implement to be repositioned without engagement of the tools with the soil, the lift wheel assembly comprising: a bracket assembly attachable to the tool bar; a main beam having a pivot arm at a first end thereof pivotally attached to the bracket assembly, a second end of the main beam adapted to receive a ground wheel capable of rotational traversal of the soil surface; and an actuator operatively connected between the bracket assembly and the main beam such that extension of the actuator pivotally displaces the main beam to position the ground wheel aft of the tool bar, and retraction of the actuator pivotally displaces the main beam to position the ground wheel in front of the tool bar.

2. The lift wheel assembly of claim 1 wherein the actuator comprises a hydraulic cylinder.

3. The lift wheel assembly of claim 1 wherein the actuator further comprises, a trunion extending from an outer wall of the actuator, and an actuator shaft extensible from the actuator, the trunion pivotally attaching the actuator to the main beam and an end of the actuator shaft attached to the bracket assembly.

4. The lift wheel assembly of claim 1 wherein the bracket assembly comprises a rear bracket element pivotally connected to said pivot arm.

5. The lift wheel assembly of claim 4 wherein the rear bracket element further comprises an aft mechanical stop engagable with a forward end of the pivot arm at a point of maximum rearward displacement of the main beam.

6. The lift wheel assembly of claim 1 wherein the bracket assembly further comprises an actuator arm extending downwardly of the bracket assembly for attachment of a working end of the actuator.

7. The lift wheel assembly of claim 1 wherein the bracket assembly further comprises a forward mechanical stop, engabable with a forward surface of the main beam to set a point of maximum forward displacement of the main beam.

8. The lift wheel assembly of claim 7 wherein the forward mechanical stop is adjustable to selectably set the point of maximum forward displacement of the main beam.

9. The lift wheel assembly of claim 1 wherein the bracket assembly comprises a forward bracket element and an aft bracket element adapted for mating engagement of the toolbar between the forward bracket element and the aft bracket element.

10. The lift wheel assembly of claim 9 wherein the rearward bracket element comprises a rearwardly extending arm having a pivot aperture extending transversely through the rearwardly extending arm, the aperture receiving a pivot pin operatively connecting the pivot arm to the rearwardly extending arm.

11. The lift wheel assembly of claim 9 wherein the rearward bracket element comprises a rearwardly extending arm, having an aft mechanical stop engagable with a forward end of the pivot arm to set a point of maximum rearward displacement of the main beam.

12. The lift wheel assembly of claim 9 wherein the rearward bracket element further comprises an actuator arm extending downwardly of the bracket assembly for attachment of a working end of the actuator.

13. The lift wheel assembly of claim 9 wherein the forward bracket element comprises a forward mechanical stop engabable with a forward surface of the main beam to set a point of maximum forward displacement of the main beam.

14. The lift wheel assembly of claim 13 wherein the forward mechanical stop is adjustable to selectably set the point of maximum forward displacement of the main beam.

15. The lift wheel assembly of claim 13, wherein the point of maximum forward displacement is selected such that the ground wheel supports the implement to gauge the engagement of the tools with the soil at a desired depth.

16. In an implement drawn across the surface of a field, the implement having a support frame with at least one tool bar receiving a plurality of tools for working soil in the field and a center of gravity, the improvement comprising: a lift wheel assembly having a lift beam pivotally coupled to the implement at a pivot arm extending from a first end of the lift beam, a ground wheel rotationally disposed at a second end of the lift beam; and an actuator having a first end attached at a fixed attachment point relative the implement frame and a second end attached to and operative on the lift beam via a trunion, the actuator operable for fore and aft pivotal displacement of the lift beam such that extension of the actuator positions the ground wheel aft of the center of gravity in an implement transporting condition, and retraction of the actuator positions the ground wheel forward of the center of gravity in an implement gauging condition.

17. The improvement of claim 16, wherein a bracket assembly pivotally couples the lift wheel assembly to the toolbar by a pivot pin extending through a forward end of the pivot arm and a first bracket arm extending rearwardly relative the toolbar.

18. The improvement of claim 17, wherein the bracket assembly further comprises an aft mechanical stop engagable with a forward surface of the pivot arm, such that engagement of the mechanical stop with the pivot arm limits the rearward displacement of the lift beam.

19. The improvement of claim 17, wherein the bracket assembly further comprises an actuator arm extending downwardly relative the toolbar, the actuator arm having aperture at an end thereof defining the fixed attachment point for the actuator first end.

20. The improvement of claim 17, wherein the bracket assembly further comprises a forward mechanical stop engagable with a forward surface of the lift beam such that engagement of the lift beam with the forward mechanical stop gauges the tool engagement with the soil at a desired depth.

21. A method of configuring a farm implement between a working state and a transport state such that in the working state, a plurality of tools mounted to a transverse toolbar of the farm implement engage with and work soil in a field at a desired gauge depth, and in the transport state, the tools are elevated above the soil surface permitting the farm implement to be repositioned over the field without engagement of the tools with the soil, the method comprising:
(a) providing a plurality of lift wheel assemblies to the farm implement, the lift wheel assemblies having a lift beam pivotally coupled to the farm implement by a lift arm extending from a first end of the lift beam and a ground wheel rotationally disposed at a second end of the lift beam;
(b) providing an actuator having a first end attached to a fixed point relative the tool bar and operable on the lift beam via a trunion attached to the first end of the lift beam,
(c) extending the actuator to elevate the farm implement tools above the soil surface and position the ground wheel aft of a center of gravity for the implement; and
(d) retracting the actuator to lower the farm implement tools for engagement with the soil and position the ground wheel forward of the center of gravity.

22. The method of claim 21 further comprising providing the lift assemblies with an aft mechanical stop engagable with a forward end of the lift arm to limit the rearward displacement of the lift beam upon extension of the actuator.

23. The method of claim 22 further comprising selecting the position of the mechanical stop such that the weight of the implement will maintain the position of the lift beam and ground wheel aft of the center of gravity without force being applied by the actuator.

24. The method of claim 21 further comprising providing a forward mechanical stop engagable with a forward surface of the lift beam to limit the forward displacement of the lift beam and ground wheel upon retraction of the actuator.

25. The method of claim 24 further comprising, selecting a position for the forward mechanical stop such that the ground wheel gauges the tool engagement with the soil.

26. Apparatus for selectively positioning a farm implement between a towed working position and a towed travel position, comprising in combination:
a. A wheel mounted for rotation on a lift beam for supporting said farm implement in said towed working position and said towed travel position;
b. A bracket operatively connected to said farm implement to move concomitantly therewith and pivotally connected to said lift beam; and
c. An actuator connected between said lift beam and said bracket for selective elongation such that said actuator moves said wheel between a position forward of said bracket supporting said bracket at a first elevation and a position aft of said bracket supporting said bracket at a higher elevation.
